(19) United States
(12) Patent Application Publication
(10) Pub. No.: US 2017/0159336 A1
(43) Pub. Date: Jun. 8, 2017

(54) Magnetic Doorstop Systems

(71) Applicant: Michael Parriott, Escondido, CA (US)

(72) Inventor: Michael Parriott, Escondido, CA (US)

(21) Appl. No.: 15/286,501

(22) Filed: Oct. 5, 2016

Related U.S. Application Data
(63) Continuation-in-part of application No. 14/960,634, filed on Dec. 7, 2015, now abandoned.

(51) Int. Cl. E05C 17/56; E05F 5/06

(52) U.S. Cl. CPC E05C 17/56; E05F 5/06

(57) ABSTRACT

A magnetic doorstop system useful for holding a door in an open position, which may include a cover-end, a first part, and a second part. The cover-end may have cushioning properties and may be placed over an end of an existing doorstop without removing the doorstop from an installed condition. The plate may be adhesively-attached to a bottom of a door. The cover-end and the second part may each have an embedded magnet such that when the door is fully opened, the two magnetic pieces may engage and retain the door in an open condition. When installed, the cover-end and the second part may jointly act in combination to prevent damage to an adjacent wall from the door or door hardware when the door is in an opened condition.

### CROSS-REFERENCE TO RELATED APPLICATION

The present application is a continuation in part and relates to and claims priority from prior provisional application Ser. No. 62/210,855, filed Aug. 27, 2015 and pending non-provisional utility patent application Ser. No. 14/960,634, filed Dec. 7, 2015, which applications are incorporated herein by reference.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

1. Field of the Invention

The present invention relates generally to the field of devices for retaining a door in an open orientation and more specifically relates to magnetic doorstop systems.

2. Description of Related Art

A doorstop may serve the purpose to either hold the door open, or prevent damage to an interior wall, or both. A doorstop, when engaged, may prevent a door and attached door handle hardware from coming in contact with, and potentially damaging, a surface such as a household interior wall. Another type of doorstop device may be purposed to retain a door in an opened configuration so as to enable a person to enter and exit the doorway area without restriction.

Doorstops may be as simple as placing a heavy object next to the door, thus preventing the door from moving. The type of object used may be heavier than necessary, or may be large enough to impede unrestricted passage through the doorway area; neither being desirable. A different object which may be used to prevent a door from moving may be a rubber, plastic or a wooden wedge that may be kicked under the door and the downward force of the door, in conjunction with the doorstop, provides static friction which may prevent door motion. These devices may pose tripping hazards and may also require that a person bend over to place or remove the device every time that they wish to change the orientation of the door from an open to a closed configuration; neither of these types of doorstops are desirable.

A common type of doorstop device, especially in home installations, which may prevent the door and door handle hardware from impacting and damaging an interior wall by applying a stopping mechanism to the door or adjacent wall may be a metal bar or spring which traditionally has an end with a spiral feature which may allow the bar or spring to be screwed into the wall or baseboard adjacent to the door. In some embodiments, the metal bar or spring may have decorative characteristics. However, this type of doorstop device does not provide any assistance with retaining a door in an open position for example when carpet cleaning or moving of items in and out of a residence when this would be a desirable option.

The heavy object and rubber, plastic, or wood wedge type of doorstops may retain a door in an open position, however, they may not offer protection to adjacent walls and damage may be incurred when placing the heavy object or kicking the wedge under the door while the door may be touching the adjacent wall. A suitable solution is desired.

Several attempts have been made to solve the above-mentioned problems such as those found in U.S. Pat. No. 3,701,557 to James Vincent Centofante; U.S. Pat. No. 3,163,453 to Stephens Floyd L; U.S. Pat. No. 8,567,831 to Joseph R. Roti; U.S. Pat. No. 3,791,687 to H Schroeder; U.S. Pat. No. 4,995,655 to Richard A. Freeman; and U.S. Pat. No. 3,244,443 to Rodgers Marion E. This art is representative of retaining devices for use with doors to maintain them in an open orientation. However, none of the above inventions and patents, taken either singly or in combination, is seen to describe the invention as claimed.

Preferably, a magnetic doorstop system should be able to be quickly and easily installed on an existing doorstop in homes and other buildings to provide a magnetic means to hold a door in an open condition, then provide that it may be readily uncoupled, when desired, to allow the door to be closed and, yet would operate reliably and be manufactured at a modest expense. Thus, a need exists for a convenient, reliable, and economical magnetic doorstop system to avoid the above-mentioned problems.

### BRIEF SUMMARY OF THE INVENTION

In view of the foregoing disadvantages inherent in the known retaining devices for providing that a door is able to be kept in an open condition, the present invention provides a novel magnetic doorstop system with a cover-end that readily fits to common existing doorstops. The general purpose of the present invention, which will be described subsequently in greater detail, is to provide an easily and conveniently-installable magnetic means to hold a door in an open condition and then be able to readily uncouple the magnets to allow the door to be closed.

A magnetic doorstop system in a preferred embodiment is described herein comprising, in structural combination, a cover-end, a first part and a second part. The cover-end, the first part, and the second part are structured and arranged to be magnetically coupleable when placed in close proximity to each other to hold a door in an open condition and, when uncoupled, allow the door to be closed as desired. The cover-end may open like a clam to engulf any existing metal bar, spring, or solid plastic-type doorstop and the second part may be attached to a door via suitable means. The cover-end may comprise a flexible body, a hollow cavity, male and female locking mechanisms, adjustable size settings, an end that opens and closes like a clam, top and bottom horseshoe ends, and an engulfing or encapsulating capability, and a first magnet.

The flexible cover-end may be able to be squeezably-opened to aid in receiving an installed common doorstop, with a metal, spring, or plastic bar. Further, the flexible cover-end with a hollow cavity is able to receive the different size doorstops that exist in homes and other buildings. The cover-end may open like a clam and has a top and bottom horseshoe shaped cutout at the stem end of the cover-end enabling it to fit different size stems of existing doorstops. Once the cover-end receives the end-tip of an existing doorstop, the cover-end may close onto the stem of the doorstop and mechanically lock by virtue of a male and female locking mechanism to keep the cover-end in a secure position on the existing doorstop. The second part may comprise a front side, a rear side, an attacher, a length, a width, a cross-sectional area, and a second magnet. The first magnet and the second magnet may comprise ferro-magnetic materials or other magnetic materials (for example, rare earth magnets) that may be useful for maintaining the permanent magnetic attraction of the first to the second magnet.

The parameters of the cover-end may be defined by a hollow cavity, one end that opens like a clam, a flexible body, a top and bottom horseshoe-shaped cut out, an adjustable size setting, a male-female locking mechanism, encapsulating capabilities, and a first magnet. The parameters of the second part may be defined by the front side, the rear side, the length, the width, and the cross-sectional area. The rear side of the plate may comprise an adhesive attacher for fixedly joining the plate to a door in a manner to resist separation. When in an installed condition, the cover-end may be perpendicular relative to the plate. When in an installed condition the second part may be attached at the bottom, outer edge of a door.

The magnetic doorstop system may comprise a kit including the cover-end, the second part, and a set of user-installer instructions. The user-installer instructions may include a method of using a magnetic doorstop system, which may comprise the steps of placing the cover-end over an installed metal bar, spring, or solid plastic-type doorstop, attaching the second part which magnetically couples to the cover-end to hold the door in an open condition, and uncoupling the cover-end and the plate to allow the door to be closed.

The present invention holds significant improvements and serves as means to retain a door in an open orientation. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, magnetic doorstop systems, constructed and operative according to the teachings of the present invention.

FIG. 1 shows a perspective view illustrating a magnetic doorstop system during a ‘ready for use’ condition showing a magnetic doorstop assembly of the magnetic doorstop system as installed according to an embodiment of the present invention.

FIG. 2 shows a plurality of doorstops and a second part of the magnetic doorstop assembly comprising a second-magnet according to an embodiment of the present invention.

FIG. 3A shows a side view of magnetic doorstop system with a cover-end in an installed condition according to an embodiment of the present invention.

FIG. 3B shows a side view of the cover-end installed on a wider spring-type doorstop according to an embodiment of the present invention.

FIG. 3C shows a perspective view of the cover-end of the magnetic doorstop assembly according to an embodiment of the present invention.

FIG. 3D shows a front view of a male peg or post mechanical locking mechanism, a female circular ring locking mechanism, and an adjustable size settings according to an embodiment of the present invention.

FIG. 3E shows a side view of the cover-end and a first-magnet according to an embodiment of the present invention.

FIG. 3F shows a side view of the cover-end with the first-magnet according to an embodiment of the present invention.

FIG. 3G shows a perspective view of the second part according to an embodiment of the present invention.

FIG. 4A shows a perspective view of an installation of the magnetic doorstop system for a thin metal bar doorstop according to an embodiment of the present invention.

FIG. 4B shows a perspective view of an installation of the magnetic doorstop system for a wider spring-type doorstop according to an embodiment of the present invention.

FIG. 5 is a flowchart illustrating a method of use for the magnetic doorstop system according to an embodiment of the present invention.

The various embodiments of the present invention will hereinafter be described in conjunction with the appended drawings, wherein like designations denote like elements.

### DETAILED DESCRIPTION

As discussed above, embodiments of the present invention relate to retaining a door in an open orientation and more particularly to a magnetic doorstop system as used to provide a magnetic means to hold a door in an open condition and then allow it to be uncoupled to allow the door to be closed.

Generally speaking, magnetic doorstop systems may comprise a cover-end with a flexible body structured and arranged in a manner that may support placing the cover-end over the end of an existing metal bar, spring, or plastic-type doorstop. The cover-end engulfs and receives the metal bar, spring, or plastic-type doorstop without removing the doorstop from an installed condition. The cover-end may be structured and arranged to contain an embedded magnet, which may comprise a piece of iron with magnetic properties or alternatively, another type of metal with magnetic properties, to attract it to another piece of iron with magnetic properties or other magnetic metal. In this case, the second piece of iron or other magnetic metal may be embedded in a plate that is structured and arranged to be adhesively-attached to a door which may be associated with the existing metal bar, spring, or plastic-type doorstop, in a manner that when the door is fully opened, the two magnetic pieces may engage and retain the door in an open condition.

When installed, the cover-end and the plate may also prevent damage to an adjacent wall from the door or door hardware when the door is in an opened condition. As shown and discussed subsequently, the present invention may be found in a plurality of sizes and shapes to accommodate the device it is being retro-fitted thereto.

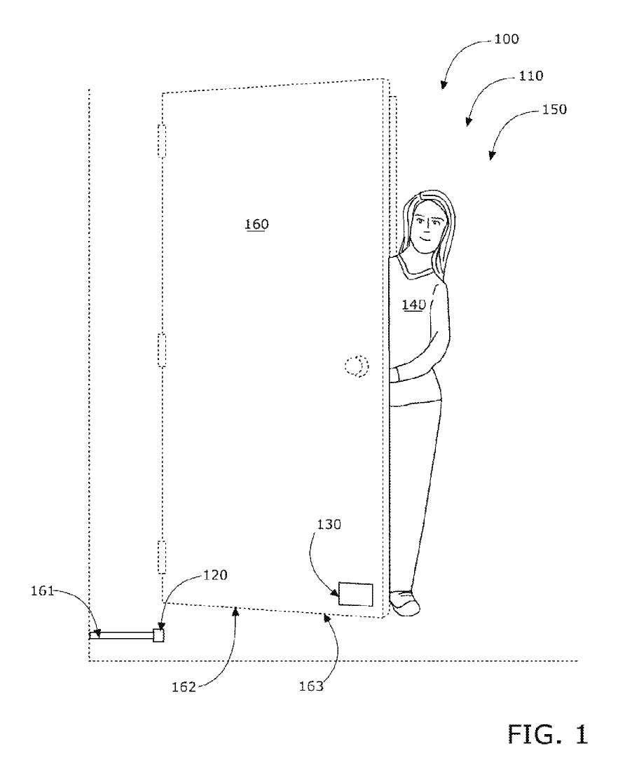

Referring to the drawings by numerals of reference there is shown in FIG. 1, a perspective view illustrating magnetic door stop system 100 in a ‘ready for use’ condition 150 showing magnetic door stop assembly 110 wherein user 140 may couple first part embedded in cover-end 120 and second part 130 to hold door 160 in an open condition, when desired, and magnetically uncouple to allow door 160 to be closed, when desired. Cover-end 120 and second part 130 are configured to be magnetically coupleable when placed in proximity of each other. Further, cover-end 120 may be fixedly attached with the end portion of an existing metal bar doorstop 161, and second part 130 may be fixedly-attached to bottom portion 162 of door 160 near outer edge 163, to align with an installed existing metal bar doorstop 161.

In continuing to refer to FIG. 1, cover-end 120, when in an installed condition, may be located proximate to second part 130. In further embodiments of the present invention, first part embedded in cover-end 120 may be fixedly adhered to door 160, and alternately a baseboard. Second part 130, when in an installed condition is attachable to bottom portion 163 of door 160 and may be in parallel and adjacent configuration to door 160. In addition, cover-end 120 may be in perpendicular relation to second part 130 when second part 130 is attached to door 160.

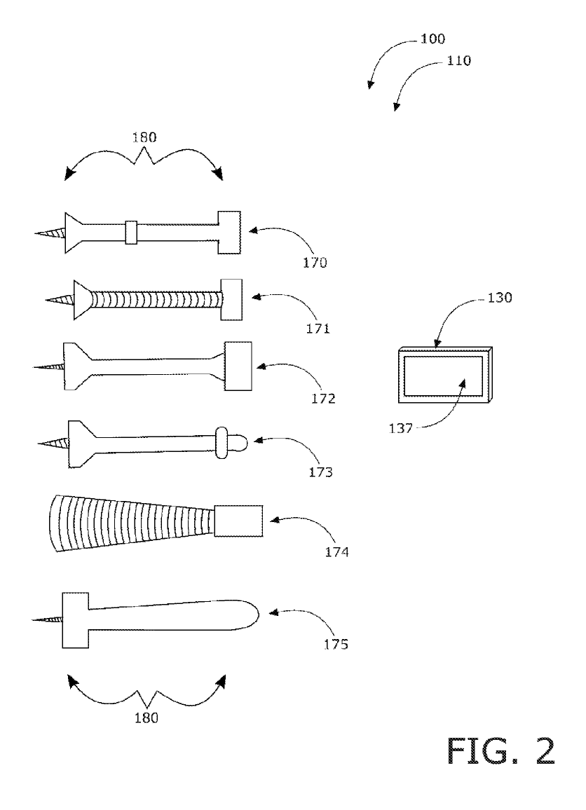

In now referring to FIG. 2, a perspective view of second part 130 with second-magnet 137 is shown in combination with doorstops of variable size 180. Doorstops of variable size 180 may include, but not be limited to, thin metal bar 170, thin spring doorstop 171, first decorative doorstop 172, second decorative doorstop 173, wider spring-type doorstop 174, and wider solid plastic-type doorstop 175. Doorstops of variable size 180 are able to receive cover-end 120.

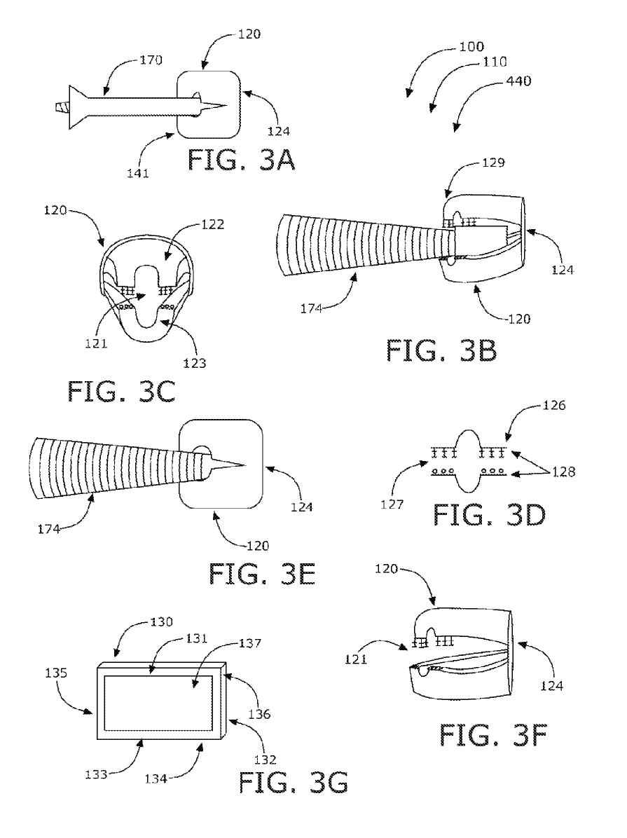

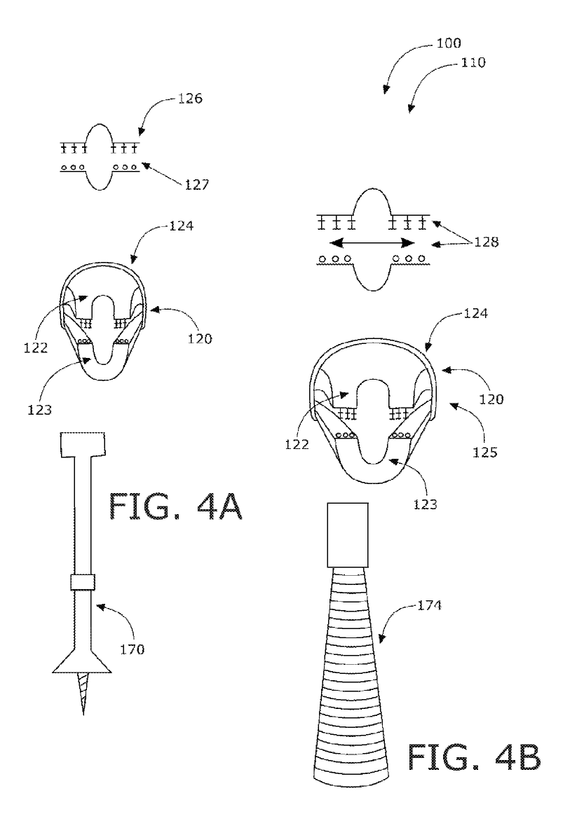

Now referring to FIG. 3A, showing a side view of magnetic doorstop system 100 with cover-end 120 in an installed condition on thin metal bar 170 doorstop style. First part comprising cover-end 120 with clam shell configuration 129 (as shown in FIG. 3B), along with with first-magnet 124 having ferrous material and flexible body 125 (as shown in FIG. 4B), is shown in locked position 141. It should be appreciated that cover-end 120 is retrofitable for doorstops of variable size 180.

In referring now to FIG. 3B showing a side view of cover-end 120 installed on wider spring-type doorstop 174. Cover-end 120, with first-magnet 124 having clam shell configuration 129, may be squeezably-opened to engulf via hollow cavity 121 (as shown in FIG. 3C) to receive different size stems of doorstops of variable size 180, such as wider spring-type doorstop 174 for example.

In now referring to FIG. 3C showing a perspective view of cover-end 120 of magnetic doorstop assembly 110. Cover-end 120 preferably comprises flexible body 125 (as shown in FIG. 4B) with hollow cavity 121 for securely receiving end portion of doorstops of variable size 180. Hollow cavity 121 is sufficiently large in relative comparison to the end portion of doorstops of variable size 180 such that the cover-end 120 positionally adjusts to align the upper horseshoe cutout 122 and lower horseshoe cutout 123 when the upper horseshoe cutout 122 and lower horseshoe cutout 123 come into contact. Upper horseshoe cutout 122 and lower horseshoe cutout 123 are able to stretch when applied to wider spring-type doorstop 174, first decorative doorstop 172, second decorative doorstop 173, and solid plastic-type doorstop 175. Upper horseshoe cutout 122 and lower horseshoe cutout 123 are configured to receive a plurality of doorstop stems of variable size 180. Cover-end 120, configured with flexible body 125 and hollow cavity 121, is an easy to install magnetic doorstop assembly 110 ready for use.

In referring now to FIG. 3D, showing a front view of male peg or post mechanical locking mechanism 126, female circular ring locking mechanism 127, and adjustable size settings 128. The male peg or post mechanical locking mechanism 126 and female circular ring locking mechanism 127 are configured to removeably-couple with each other in an installed condition. Further, adjustable size settings 128 are able to securely lock onto variably sized existing doorstop stems as shown with thin metal bar 170 (as shown in FIG. 3A) type of doorstop, and alternately wider spring-type doorstop 174 (as shown in FIG. 3B), being example installations of doorstops in most homes and other buildings.

Now referring to FIG. 3E, showing a side view of cover-end 120 and first-magnet 124, which are configured to clamp and be in a locked position 141 around a wider spring-type doorstop 174.

In now referring to FIG. 3F, showing a side view of cover-end 120 with first-magnet 124. Cover-end 120 has flexible body 125 (as shown in FIG. 4B) and further includes a clam shell configuration having hollow cavity 121. In addition, cover-end 120 is configured to have relaxed state (as shown in FIG. 4A), and alternately stretching capability via upper horseshoe cutout 122 and lower horseshoe cutout 123 (as shown in FIG. 3C), which provide the ability to allow flexible body 125 (as shown in FIG. 4B) to stretch such that upper horseshoe cutout 122 and lower horseshoe cutout 123 (as shown in FIG. 3C) are able to securely fit doorstops of variable size 180 (as shown in FIG. 2).

Referring now to FIG. 3G, showing a perspective view of second part 130. Parameters of second part 130 are defined by front side 131, rear side 132, length 134, width 135, and cross sectional area 136. In some embodiments of the present invention, second part 130 comprises a thin-profile so as to not impair normal door 160 (as shown in FIG. 1) operation. Second part 130 also comprises second-magnet 137 further comprising ferrous material, ferro-magnetic materials, or other magnetic materials (for example, rare earth magnets). Front side 131 of plate 130 comprises a hollow body structured and arranged to accept second-magnet 137. Second-magnet 137 is fixedly integrated with second part 130 in permanent installation. Second-magnet 137 of second part 130 may comprise a plurality of sizes and strengths to accommodate varying weights of hollow-core, wood, and metal doors. Cross-sectional area 136 of second part 130 comprises thickness 135 that may accept a plurality of sizes of second-magnet 137. Rear side 132 of second part 130 further comprises attacher 133 for fixedly joining second part 130 to door 160. Attacher 133 used for fixedly joining second part 130 to door 160 comprises adhesive to bind second part 130 to door 160 in a manner to resist separation. In addition, first part with cover-end 120 and second part 130 may be removably attachable to each other with first-magnet 124 (as shown in FIG. 3E) having a north pole and a second-magnet 137 having a south pole. Alternately, first magnet 124 (as shown in FIG. 3E) may have south pole and second-magnet cover-end 137 may have north pole. Second-magnet 137 may be able to be coated with an appropriate material for decorative or functional purposes.

It should be noted that magnetic door stop system 100 may be sold as kit 440 comprising the following parts: at least one first part comprising cover-end 120 at least one second part plate 130; and at least one set of user instructions. The kit 440 has instructions such that functional relationships are detailed in relation to the structure of the invention, (such that the invention can be used, maintained, or the like in a preferred manner). Magnetic door stop system 100 may be manufactured and provided for sale in a wide variety of sizes and shapes for a wide assortment of applications.

Referring now to FIG. 4A, showing a perspective view of an installation of the present invention of magnetic doorstop system 100 for thin metal bar 170 doorstop. In this view, cover-end 120 with first-magnet 124 is in a relaxed state and upper horseshoe cutout 122 and lower horseshoe cutout 123 are ready to install on thin metal bar 170 doorstop. The male peg or post mechanical locking mechanism 126 for upper horseshoe cutout 122, and female circular ring locking mechanism 127 for lower horseshoe cutout 123 are also shown in relaxed state.

Now referring to FIG. 4B, showing a perspective view of an installation of the present invention of magnetic doorstop system 100 for wider spring-type 174 doorstop. Cover-end 120 with first-magnet 124 includes upper horseshoe cutout 122 and lower horseshoe cutout 123 and flexible body 125 have stretching capability to form-fit to a wider spring-type doorstop 174. Further, male peg or post mechanical locking mechanism 126 and female circular ring locking mechanism 127 have adjustable size settings 128 to ensure fit on a plurality of sizes of stems of doorstops of variable size 180 (as shown in FIG. 2). Upon reading this specification, it should be appreciated that, under appropriate circumstances, considering such issues as user preferences, design preference, structural requirements, marketing preferences, cost, available materials, technological advances, etc., other magnetic doorstop arrangements may be provided, as shown in FIGS. 3 and 4.

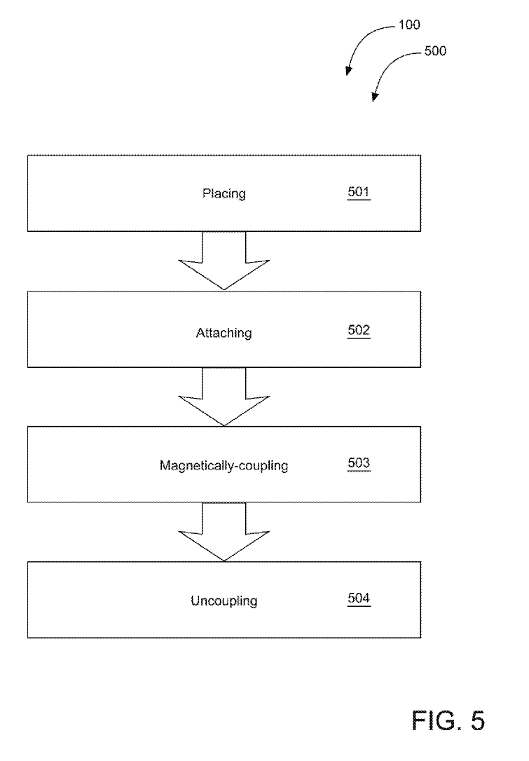

Referring now to FIG. 5 showing flowchart 550 illustrating method of use 500 for magnetic doorstop system 100 according to an embodiment of the present invention. As shown, method of use 500 may comprise the steps of: step one 501, placing cover-end 120 over an installed metal bar-type door stop 161, step two 502 attaching second part 130 to bottom of door 160, step three 503 magnetically-coupling cover-end 120 and second part 130 to hold door 160 in an open condition, and step four 504 uncoupling cover-end 120 and second part 130 to allow door 160 to be closed when desired.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within the above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A magnetic doorstop assembly comprising:
a cover-end having a hollow cavity for securely receiving an end portion of a doorstop;
a first part attached to the cover-end; and
a second part attachable to a bottom portion of the door;
wherein the first part and second part are removably attachable to each other via a first-magnet and a second-magnet; and
wherein the magnetic doorstop assembly is useful for holding a door in an open position.

2. The assembly of claim 1 wherein the first part is the first-magnet, and the second part comprises the second-magnet.

3. The assembly of claim 1 wherein the second part is the second-magnet and the first part comprises a ferrous material.

4. The assembly of claim 1 wherein the first-magnet comprises a north pole, and the second magnet comprises a south pole.

5. The assembly of claim 1 wherein the first-magnet comprises a south pole, and the second-magnet comprises a north pole.

6. The assembly of claim 1 wherein the cover-end comprises a clam shell configuration.

7. The assembly of claim 6 wherein the hollow cavity of the cover-end comprising the clam shell configuration aids to receive the end portion of the doorstop of variable size.

8. The assembly of claim 1 wherein the cover-end has at least one horseshoe cutout for receiving a stem of the doorstop.

9. The assembly of claim 8 wherein the hollow cavity is sufficiently large in relative comparison to the end portion of the doorstop such that the cover-end positionally adjusts to align the horseshoe cutout when the horseshoe cutout come into contact.

10. The assembly of claim 9 wherein the cover-end comprises a flexible body having the at least one horseshoe shaped cutout providing an ability to allow the flexible body to stretch such that the at least one horseshoe shaped cutout is able to securely fit a doorstop stem of variable size.

11. The assembly of claim 1 wherein the cover-end is fixedly attached to the end portion of the doorstop.

12. The assembly of claim 1 wherein the first part is embedded into the cover-end.

13. The assembly of claim 1 wherein the first part is fixedly adhered to the door.

14. The assembly of claim 1 wherein the first part is fixedly adhered to a baseboard.

15. The assembly of claim 1 further comprising a pair of male-and-female-mechanically-locking-components structured and configured to securely fit a doorstop stem of variable size.

16. A magnetic doorstop assembly comprising:
a cover-end having a hollow cavity for securely receiving an end portion of a doorstop;
a first part attached to the cover-end; and
a second part attachable to a bottom portion of the door;
wherein the first part and second part are removably attachable to each other via a first-magnet and a second-magnet;
wherein the cover-end comprises a clam shell configuration;
wherein the hollow cavity of the cover-end comprising the clam shell configuration aids to receive the end portion of the doorstop of variable size;
wherein the cover-end further comprises a top part and a bottom part;
wherein the top part and the bottom part each comprises at least one horseshoe-shaped cut out configured for receiving a stem of the doorstop;
wherein the cover-end is fixedly attached to the end portion of the doorstop;
wherein the first part is embedded into the cover-end;
wherein the second part is fixedly adhered to the door and alternatively a baseboard;
wherein the cover-end comprises a flexible body having an upper horseshoe cutout and a lower horseshoe cutout providing an ability to allow the flexible body to stretch such that the upper horseshoe cutout and the lower horseshoe cutout are able to securely fit a doorstop stem of variable size; and
wherein the assembly is useful for holding a door in an open position.

17. The assembly of claim 16 further comprising a pair of male-and-female-mechanically-locking-components structured and configured to securely fit a doorstop stem of variable size.

18. The magnetic doorstop system of claim 16 further comprising a kit including:
the cover-end;
the first part;
the second part; and
a set of user-installation instructions.

19. A method of a magnetic doorstop assembly comprising the steps of:
placing a cover-end over an installed doorstop;
attaching a second part to a bottom of a door;
magnetically-coupling the cover-end and the second part to hold the door in an open condition; and
uncoupling the cover-end and the second part to allow the door to be closed when desired by a user.

20. The method of claim 19 further comprising the steps of removing the magnetic doorstop assembly as desired by the user.
